(19) United States
(12) Patent Application Publication
(10) Pub. No.: US 2004/0218503 A1
(43) Pub. Date: Nov. 4, 2004

(54) Objective optical element and optical pickup device

(75) Inventor: Kiyono Ikenaka, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA OPTO, INC.

(21) Appl. No.: 10/828,207

(22) Filed: Apr. 21, 2004

(30) Foreign Application Priority Data
Apr. 22, 2003 (JP) 2003-117464

(51) Int. Cl. G11B 7/135

(52) U.S. Cl. 369/112.05; 369/112.07; 369/112.08

(57) ABSTRACT

An objective optical element and an optical pickup device at least capable of reproducing and/or recording information from and/or on a high-density optical disk and securing an even light volume. The objective optical element is made of a single lens for use in an optical pickup device at least reproducing and/or recording information from and/or on a first optical information recording medium by focusing a light beam having a wavelength λ1 (380 nm≦λ1≦450 nm) on an information recording surface of the first optical information recording medium having a protected substrate thickness t1 (0 mm<t1≦0.7 mm). The objective optical element has a convex object-side optical surface and a diffracting structure having positive diffraction power at least on one of the object-side and image-side optical surfaces, and is formed from a lens material satisfying 97≦T1≦99 where T1 (%/mm) is an optical transmittance not including a reflection loss for the light beam having the wavelength λ1.

### BACKGROUND OF THE INVENTION

1. Field of the Invention

The present invention relates to an objective optical element and an optical pickup device, and more particularly to an objective optical element and an optical pickup device having compatibility among several types of optical disks each having a protected substrate different in thickness as an optical information recording medium.

2. Description of the Related Art

In recent years, the so-called high-density optical disk is under research and development: the high-density optical disk has a recording density of an optical information recording medium (optical disk) increased by using a blue laser beam having a wavelength (λ) in the order of 400 nm so as to increase a storage capacity.

As for the specifications of the high-density optical disk, there are known high-density optical disks having, for example, an image-side numerical aperture (NA) of an objective lens in the order of 0.85, a thickness of a protected substrate of approx. 0.1 mm, or NA and a thickness of a protected substrate suppressed to approx. 0.65 and approx. 0.6 mm equal to those of a conventional digital video disk (DVD). In the following description, a high-density optical disk having NA in the order of 0.65 and the protected substrate thickness in the order of 0.6 mm is referred to as “advanced optical disc (AOD).”

There have been suggested various technologies related to this type of optical pickup device capable of reproducing and/or recording information from and/or on the high-density optical disk (Refer to, for example, Japanese Unexamined Patent Publication (Kokai) No. 2002-203333).

An outgoing beam from a light source passes through an objective lens and forms a focused spot on an information recording surface of an optical disk. In general, however, there is such a problem that a light volume of a beam passing through a high NA area (an area radially far from a light axis) on a plane of incidence decreases in comparison with a light volume of a beam passing through a low NA area (an area close to the light axis), in other words, that a light loss through the high NA area relatively increases in comparison with that through the low NA area, thereby causing a variance (unevenness) of the outgoing beam from the objective lens, being affected by, for example, a diffracting structure formed on an optical surface of the objective lens or an antireflection coating for preventing a surface reflection of an incident light.

For example, describing a case where diffraction zones 100, each having sawtooth crass-section, around a light axis L is formed on a convex plane of incidence of an objective lens 101 as a diffracting structure as shown in FIG. 1, an angle θ1 formed between the light axis L and a light beam P1 having passed through the diffracting structure in the high NA area is large in comparison with an angle θ2 formed between the light axis L and a light beam P2 having passed through the diffracting structure in the low NA area.

Generally, out of the light beam having passed through the surface of the diffraction zones 100, a light beam (P3) having reached a stepped surface 102 of the diffraction zones 100 is shut off by the stepped surface 102, thereby not contributing to a formation of a focused spot and thus causing a loss of the light volume. Then, the loss of the light volume is remarkable in the high NA area with a large angle formed between the light beam and the light axis.

Furthermore, the antireflection coating is often formed by, for example, a vacuum deposition. In an objective lens having a great NA for use in a high-density optical disk, however, the plane of incidence has a higher curvature in a higher NA area and therefore a film thickness of the antireflection coating in the higher NA area is greater, thus causing an uneven coating. Thereby, the uneven coating reduces an antireflection effect in the higher NA area and it causes a large loss of the light volume consequently.

In the above gazette, there has been disclosed a technology of achieving compatibility between two types of optical disks by making corrections for aberration by using an objective lens made of two lenses combined, namely, a first lens and a second lens and providing diffraction zones on at least one of a plane of incidence and a plane of emission of each lens.

If an objective lens is made of two lenses combined as described above, there are four optical surfaces where the diffraction zones can be provided in total, namely, the plane of incidence and the plane of emission of each lens. The structure expands the possibility of design and allows an easy selection of an optical surface that is unlikely to have a loss of the light volume.

If an object lens is made of a single lens, however, diffraction zones must be provided in one of a plane of incidence and a reflective face of the single lens. Therefore, it has only a little choice in a design phase and it is hard to design a lens preventing the loss of the light volume.

Particularly if an objective lens made of a single lens is used for an optical pickup device having compatibility among a plurality of optical disks, an aberration occurs due to a difference in a wavelength of a light beam to be used or a difference in a thickness of a protected substrate. Therefore, it is hard to design a lens capable of securing a light volume necessary for reproducing and/or recording information from and/or on each optical disk and further capable of securing an even light volume.

Still further, in the conventional technology including the disclosure in the above gazette, there is no consideration about means for resolving the loss of the light volume in the high NA area caused by the effect of the steps of the diffraction zones. Therefore, it is hard to resolve the above problem independently of whether the objective lens is made of a single lens or a plurality of lenses (for example, two lenses).

### SUMMARY OF THE INVENTION

The present invention has been made in view of the foregoing problems in the related art, and has as its object to provide an objective optical element and an optical pickup device at least capable of reproducing and/or recording information from and/or on a high-density optical disk and securing an even light volume.

To achieve the above object, according to a first aspect of the present invention, there is provided an objective optical element for use in an optical pickup device at least reproducing and/or recording information from and/or on a first optical information recording medium by focusing a first light beam having a wavelength λ1 (380 nm≦λ1≦450 nm) on an information recording surface of said first optical information recording medium having a protected substrate thickness t1 (0 mm<t1≦0.7 mm), wherein the objective optical element has a single lens having a convex optical surface on the object side, a diffracting structure having positive diffraction effects formed at least on one of optical surfaces thereof, and an internal transmittance of the first light varying in response to a distance that the first light beam passes through the single lens.

With the above feature in the first aspect, the object-side optical surface of the single lens is convex and the internal transmittance of the light beam having the wavelength λ1 varies with the distance that the light beam having the wavelength λ1 passes through the objective optical element. The “variance of the internal transmittance” occurs due to a light absorption into the material during the light passage through the lens material. Therefore, a loss of the light volume becomes smaller as a distance that the first light beam passes through the single lens a shorter, and therefore the light volume of the outgoing beam having the wavelength λ1 increases relatively in comparison with the case of a light passage of a longer distance.

Accordingly, even if a light beam has reached the inside of the objective optical element without being affected by steps of diffraction zones and an antireflection coating, the light volume is slightly decreasing during travelling within the objective optical element. The decrease becomes greater in proportion to a distance that the light beam passes through the objective lens, and thus it becomes greater in the vicinity of a light axis and becomes smaller in a high NA area.

As stated above, a difference between the vicinity of the light axis and the high NA area becomes smaller in comparison with the conventional objective optical element by the relatively substantial decrease of the light volume of the light beam passing through the vicinity of the light axis, in view of the light volume of the light beam emitted from the plane of emission of the objective lens. Therefore, the light volume of the outgoing beam can be equalized within the range of the light volume necessary for reproducing and/or recording information from and/or on the first optical information recording medium.

According to a second aspect of the present invention, there is provided an objective optical element for use in an optical pickup device at least reproducing and/or recording information from and/or on a first optical information recording medium by focusing a first light beam having a wavelength λ1 (380 nm≦λ1≦450 nm) on an information recording surface of the first optical information recording medium having a protected substrate thickness t1 (0 mm<t1≦0.7 mm), wherein the objective optical element is formed by a plurality of optical elements; wherein there is provided a convex optical surface on an object side of at least one of the plurality of optical elements and a diffracting structure having positive diffraction effects is formed at least on one of optical surfaces thereof; and wherein an internal transmittance of the first light in at least one of the plurality of the optical elements varies in response to a distance that the first light beam passes through the optical element.

With the above feature in the second aspect, even if the objective optical element is formed by combining two or more optical elements, it is possible to achieve the same effects as in the first aspect of the present invention.

According to a third aspect of the present invention, there is provided an optical pickup device, comprising the objective optical element according to the first or second aspect.

As apparent from the above respective aspects, according to the present invention, it is possible to achieve an objective optical element and an optical pickup device at least capable of reproducing and/or recording information from and/or on a high-density optical disk.

In addition, it is possible to achieve an objective optical element and an optical pickup device having compatibility among several types of optical disks having protected substrates different in thickness as optical information recording mediums and capable of securing an even light volume.

The above and many other objects, features and advantages of the present invention will become manifest to those skilled in the art upon making reference to the following detailed description and accompanying drawings in which a preferred embodiment incorporating the principle of the present invention is shown by way of illustrative examples.

### BRIEF DESCRIPTION OF THE DRAWINGS

FIG. 1 is a relevant part enlarged transverse sectional view of an objective lens for explaining a loss of a light volume on stepped surfaces of diffraction zones;

FIG. 2 is a schematic view showing an outline structure of an optical pickup device according to one embodiment of the present invention;

FIG. 3 is a transverse sectional view showing a relevant part of an objective lens for use in the optical pickup device of the present invention; and

FIG. 4 is a graph showing a relation between an optical transmittance and a numerical aperture of the objective lens and a relation between an internal transmittance and the numerical aperture for use in the optical pickup device according to the present invention.

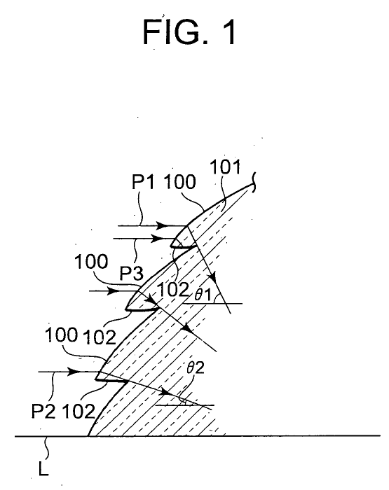

### DETAILED DESCRIPTION OF THE PREFERRED EMBODIMENTS

In an objective optical element as set forth in the first aspect of the present invention, it is preferable that the internal transmittance of the first light beam in the single lens becomes greater as a distance that the first light beam passes through the single lens is shorter.

In an objective optical element as set forth in the first aspect of the present invention, it is preferable that the objective optical element satisfies 97≦T1<99 where T1 [%/mm] is an optical transmittance for a thickness of 1 mm in the single lens not including a reflection loss for the first light beam.

According to this feature, the object-side optical surface of the objective optical element is convex and the optical transmittance T1 of the lens material is within the range of 97≦T1≦99 and therefore T1 is not equal to 100. Accordingly, even if a light beam has reached the inside of the objective optical element without being affected by steps of diffraction zones and an antireflection coating, its light volume slightly decreases during travelling within the objective optical element. The decrease becomes greater in proportion to a distance that the light beam passes through the objective lens, and thus it becomes greater in the vicinity of a light axis and smaller in a high NA area.

As stated above, a difference between the vicinity of the light axis and the high NA area becomes smaller in comparison with the conventional objective optical element by the relatively substantial decrease of the light volume of the light beam passing through the vicinity of the light axis, in view of the light volume of the light beam emitted from the plane of emission of the objective lens. Therefore, the light volume of the outgoing beam can be equalized within the range of the light volume necessary for reproducing and/or recording information from and/or on the first optical information recording medium.

In an objective optical element as set forth in the first aspect of the present invention, it is preferable that the objective optical element satisfies |Δλ|≦0.040 where Δλ [λ rms] is a wave aberration of a focused spot in a condition where the wavelength has changed by 1 nm from λ1 in a focused spot position where the wave aberration is a minimum at the time of incidence of the first light beam.

According to this feature, even if a wavelength of the outgoing beam from a light source has changed due to, for example, a mode hop, it is possible to perform so-called color correction for decreasing an axial chromatic aberration and a spherical chromatic aberration to the diffraction limit or lower.

In an objective optical element as set forth in the first aspect of the present invention, it is preferable that the objective optical element satisfies 50≦νd1≦60 where νd1 is an Abbe number of the lens material for the light beam having the wavelength λ1.

According to this feature, it is possible to decrease a wavelength dependency to a low level. For example, even if a mode hop occurs at the time of recording information on an optical disk, it is possible to decrease a change of a refractive index to a low level and to reduce a variance in a direction of the light axis of the focused spot.

In an objective optical element as set forth in the first aspect of the present invention, it is preferable that the objective optical element satisfies 0.63≦hmax/f1≦0.67 and 0.5 mm≦t1≦0.7 mm where hmax is a maximum height from a light axis of the light beam having the wavelength λ1 incident on the object-side optical surface and f1 is a focal length of the objective optical element for the light beam having the wavelength λ1, and that the objective optical element satisfies 0.25≦ΔL1/L1≦0.5 where L1 [mm] is a distance that the light beam having the wavelength λ1 passes on the light axis within the objective optical element and ΔL1 [mm] is a distance that the light beam having the wavelength λ1 incident on the object-side optical surface at the height hmax passes through an area within the objective optical element. In addition, the distance L1 is within the range of 1.4≦L1≦2.5, and further the focal length f1 [mm] for the light beam having the wavelength λ1 is within the range of 0≦f1≦4.0.

According to the above features, it is possible to enhance the effect of equalizing the light volume of the outgoing beam when using an AOD.

In an objective optical element as set forth in the first aspect of the present invention, it is preferable that the objective optical element satisfies 0.83≦hmax/f1≦0.87 and 0.09 mm≦t1≦0.11 mm where hmax is a maximum height from a light axis of the light beam having the wavelength λ1 incident on the object-side optical surface and f1 is a focal length of the objective optical element for the light beam having the wavelength λ1, and that the objective optical element satisfies 0.35≦ΔL1/L1≦0.6 where L1 [mm] is a distance that the light beam having the wavelength λ1 passes on the light axis within the objective optical element and ΔL1 [mm] is a distance that the light beam having the wavelength λ1 incident on the object-side optical surface at the height hmax passes through an area within the objective optical element. In addition, the distance L1 is within the range of 1.4≦L1≦2.5, and further the focal length f1 [mm] for the light beam having the wavelength λ1 is within the range of 1.0≦f1≦2.5.

According to these features, it is possible to enhance the effect of equalizing the light volume of the outgoing beam when using a high-density optical disk with a protected substrate thickness in the order of 0.09 mm≦t1≦0.11 mm.

In an objective optical element as set forth in the first aspect of the present invention, it is preferable that the objective optical element is for use in an optical pickup device further capable of reproducing and/or recording information from and/or on a second optical information recording medium by focusing a light beam having a wavelength λ2 (640 nm≦λ2 680 nm) on an information recording surface of the second optical information recording medium having a protected substrate thickness t2 (0.5 mm≦t2≦0.7 mm).

According to this feature, it is possible to achieve an objective optical element for use in the optical pickup device having compatibility between a high-density optical disk and a DVD.

In an objective optical element as set forth in the first aspect of the present invention, it is preferable that the objective optical element is for use in an optical pickup device further capable of reproducing and/or recording information from and/or on a third optical information recording medium by focusing a light beam having a wavelength λ3 (750 nm≦λ3≦850 nm) on an information recording surface of the third optical information recording medium having a protected substrate thickness t3 (1.1 mm≦t3≦1.3 mm).

According to this feature, it is possible to achieve an objective optical element for use in an optical pickup device having compatibility among a high-density optical disk, a DVD, and a CD.

In an objective optical element as set forth in the second aspect of the present invention, it is preferable that the internal transmittance of the first light beam in the optical element, in which the internal transmittance of the first light beam varies in response to a distance that the first light beam passes through the optical element, becomes greater as a distance that the first light beam passes through the objective optical element is shorter.

In an objective optical element as set forth in the second aspect of the present invention, it is preferable that the objective optical element satisfies 97≦T1≦99 where T1 [%/mm] is an optical transmittance for a thickness of 1 mm in the optical element, in which the internal transmittance of the first light beam varies in response to a distance that the first light beam passes through the optical element, not including a reflection loss for the first light beam.

In an objective optical element as set forth in the second aspect of the present invention, it is preferable that the objective optical element satisfies |Δλ|≦0.040 where Δλ[λ rms] is a wave aberration of a focused spot in a condition where the wavelength has changed by 1 nm from λ1 in a focused spot position where the wave aberration is a minimum at the time of incidence of the first light beam.

In an objective optical element as set forth in the second aspect of the present invention, it is preferable that the objective optical element satisfies 50≦νd1≦60 where νd1 is an Abbe number of the lens material, which consists of the optical element in which the internal transmittance of the first light beam varies in response to a distance that the first light beam passes through the optical element, for the first light beam.

In an objective optical element of the present invention, it is preferable that the lens material consisting of the single lens is resin.

Hereinafter, some preferred embodiments of an objective optical element (objective lens) and an optical pickup device according to the present invention will now be described in detail with reference to the accompanying drawings.

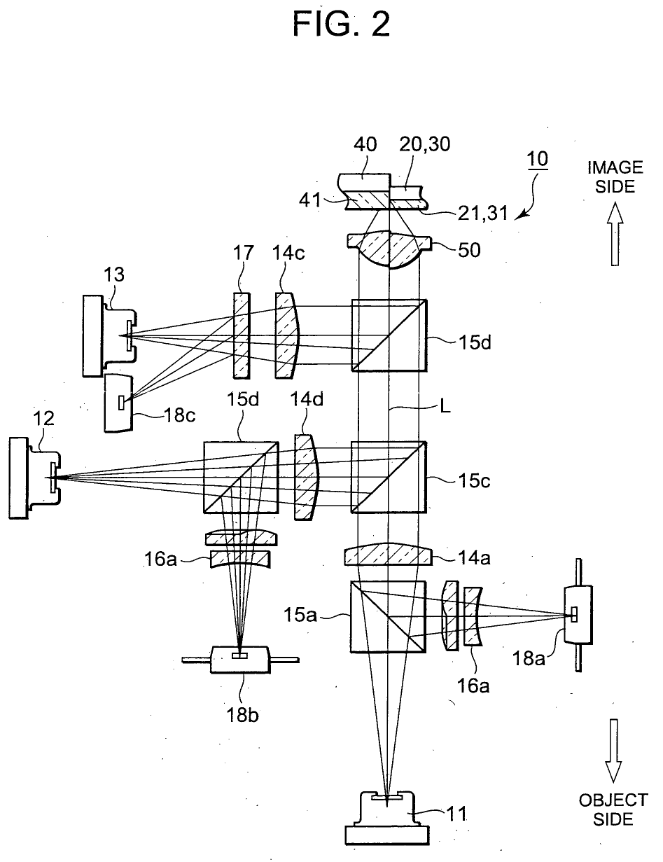

As shown in FIG. 2, in this embodiment, an optical pickup device 10 comprises a first light source 11 to a third light source 13 for emitting light beams having a wavelength λ1 (380 nm≦λ1≦450 nm), a wavelength λ2 (640 nm≦λ2≦680 nm), and a wavelength λ3 (750 nm≦λ3≦850 nm), respectively.

Furthermore, the optical pickup device 10 is arranged to have compatibility among three types of optical disks in such a way that information is recorded and/or reproduced on and/or from a first optical information recording medium 20 (an AOD in this embodiment) with a thickness t1 (0.5 mm≦t1≦0.7 mm) of a protected substrate 21, a second optical information recording medium 30 (a DVD in this embodiment) with a thickness t2 (0.5 mm≦t2≦0.7 mm) of a protected substrate 31, and a third optical information recording medium 40 (a CD in this embodiment) with a thickness t3 (1.1 mm≦t3≦1.3 mm) of a protected substrate 41 by using the light beams stated above. In FIG. 2, the protected substrate 21 of the AOD and the protected substrate 31 of the DVD having substantially the same thickness (t1 and t2) are shown by the same illustration.

An objective lens 50 and an optical pickup device 10 according to the present invention are applied at least to a first optical information recording medium 20 as a high-density optical disk. Therefore, if the optical pickup device 10 is used exclusively for a high-density optical disk, it is only required to remove a second light source 12, a second beam splitter 15b, a third beam splitter 15c, a second collimating lens 14b, a concave lens 16a, a second optical detector 18b, a DVD, a third light source 13, a diffracting plate 17, a third collimating lens 14c, a third optical detector 18c, a fourth beam splitter 15d, and a CD from the components in FIG. 2. If the optical pickup device 10 is used as the optical pickup device 10 for compatibility between a high-density optical disk and a DVD, it is only required to remove the third light source 13, the diffracting plate 17, the third collimating lens 14c, the third optical detector 18c, the fourth beam splitter 15d, and the CD.

First, a configuration of the optical pickup device 10 is described below.

As shown in FIG. 2, the optical pickup device 10 generally comprises first to third light sources 11 to 13, first to third collimating lenses 14a to 14c, first to fourth beam splitters 15a to 15d, an objective lens 50 formed of a single lens, a two-dimensional actuator (not shown) for moving the objective lens 50 in a given direction, a concave lens 16a, a diffracting plate 17, and first to third optical detectors 18a to 18c for detecting reflected lights from optical disks.

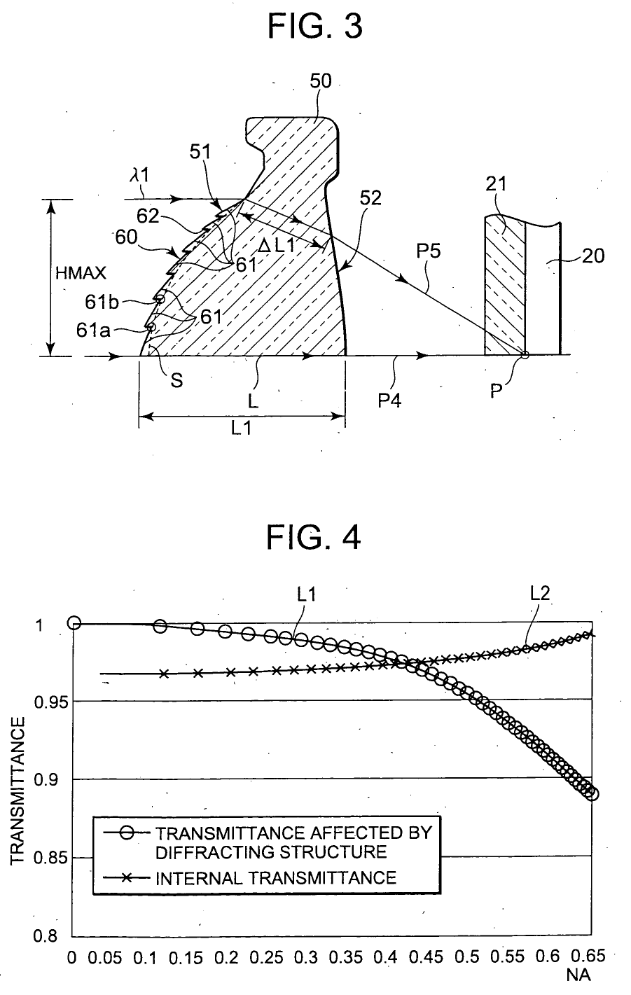

As mentioned above, an AOD is used as the first optical information recording medium 20 in this embodiment. Therefore, as shown in FIG. 3, the objective lens 50 satisfies 0.63≦hmax/f1≦0.67 and 0.5 mm≦t1≦0.7 mm where hmax is the maximum height from a light axis L of a light beam having a wavelength λ1 incident on an object-side optical surface (a plane of incidence 51) of the objective lens 50 and f1 is a focal length of the objective lens 50 for the light beam having the wavelength λ1.

It is also possible to use the so-called holo laser unit, though it is not shown: the holo laser unit is formed by integrally combining the second optical detector 18b with the second light source 12 or the third optical detector 18c with the third light source 13, in which a light beam having a wavelength λ2 or λ3 reflected on an information recording surface of a DVD or a CD follows the same optical path as for an outward route when it returns and reaches a hologram element, which modifies its course, thereby causing the light beam to be incident on the optical detector.

In this embodiment, a condensing optical system comprises the first to third collimating lenses 14a to 14c, the first to fourth beam splitters 15a to 15d, and the objective lens 50.

In addition, the light beams having wavelengths λ1 to λ3, respectively, are modified into substantially parallel beams by the first to third collimating lenses 14a to 14c and then incident on the objective lens 50. In other words, the so-called infinite-system configuration satisfying m1=m2=m3=0, where m1, m2, and m3 are optical system magnifications of the objective lens 50 for the light beams having the wavelengths λ1, λ2, and λ3, respectively.

It can be changed appropriately by means of designing whether to cause the light beams having the wavelengths λ1 to λ3 to be incident as diverging beams on the objective lens 50 or to cause the light beams to be incident as parallel beams on the objective lens 50. For example, it is possible to apply a configuration for causing the light beams having the wavelengths λ2 and λ3 to be incident as diverging beams on the objective lens 50 or a configuration for causing only the light beam having the wavelength λ3 to be incident as a diverging beam on the objective lens 50.

An operation of the optical pickup device 10 having the above configuration is already known, and therefore a detailed description thereof is omitted here. It should be noted, however, that the light beam having the wavelength λ1 emitted from the first light source 11 passes through the first beam splitter 15a, is modified into a parallel beam by the first collimating lens 14a, and then passes through the third and fourth beam splitters 15c and 15d. Since a diffracting structure 60 is formed on the plane of incidence 51 of the objective lens 50, though it will be described later in detail, a light beam having the wavelength λ1 takes a refraction on the plane of incidence 51 and the plane of emission 52 and takes a diffraction on the plane of incidence 51 before it is emitted.

Thereafter, a diffraction light having the maximum diffraction efficiency out of the light beam having the wavelength λ1 having taken the diffraction due to the diffracting structure 60 focuses on the information recording surface of the AOD and forms a spot on the light axis L. Then, the light beam having the wavelength λ1 focused into the spot is modulated on the information recording surface by an information pit and then reflected. The reflected light beam passes through the objective lens 50, the fourth and third beam splitters 15d and 15c, and the first collimating lens 14a again, and it is reflected by the first beam splitter 15a and diverges.

The diverging light beam having the wavelength λ1 is incident on the first optical detector 18a via the concave lens 16a. The first optical detector 18a detects the spot of the incident light and outputs a signal. By using the output signal, it obtains a read signal of the information recorded on the AOD.

In addition, a focus or a track is detected by detecting a change of a light volume or the like depending on a shape or position change of the spot on the first optical detector 18a. On the basis of a result of the detection, the two-dimensional actuator not shown moves the objective lens 50 in a focusing direction and a tracking direction so that the light beam having the wavelength λ1 forms an accurate spot on the information recording surface.

The light beam having the wavelength λ2 emitted from the second light source 12 passes through the second beam splitter 15b, is modified into a parallel beam by the second collimating lens 14b and reflected by the third beam splitter 15c, and passes through the fourth beam splitter 15d before it reaches the objective lens 50. Thereafter, the light beam takes refraction on the plane of incidence 51 and the plane of emission 52 of the objective lens 50 and takes diffraction on the plane of incidence 51 before it is emitted.

The diffraction light having the maximum diffraction efficiency out of the light beam having the wavelength λ2 having taken the diffraction due to the diffracting structure 60 focuses on the information recording surface of the DVD and forms a spot on the light axis L. Then, the light beam having the wavelength λ2 focused into the spot is modulated on the information recording surface by the information pit and then reflected. The reflected light beam passes through the objective lens 50 and the fourth beam splitter 15d, and it is reflected by the third beam splitter 15c and diverges.

The diverging light beam having the wavelength λ2 passes through the second collimating lens 14b, and it is reflected by the second beam splitter 15b and diverges. Thereafter, it is incident on the second optical detector 18b via the concave lens 16a. The subsequent procedure is the same as for the light beam having the wavelength λ1.

The light beam having the wavelength λ3 emitted from the third light source 13 passes through the diffracting plate 17 provided instead of the beam splitter and it is modified into a parallel beam by the third collimating lens 14c. Then, it is reflected by the fourth beam splitter 15d and reaches the objective lens 50. Thereafter, the light beam takes refraction on the plane of incidence 51 and the plane of emission 52 of the objective lens 50 and takes diffraction on the plane of incidence 51 before it is emitted.

The diffraction light having the maximum diffraction efficiency out of the light beam having the wavelength λ3 having taken the diffraction due to the diffracting structure 60 focuses on the information recording surface of the DVD and forms a spot on the light axis L. Then, the light beam having the wavelength λ3 focused into the spot is modulated on the information recording surface by the information pit and then reflected. The reflected light beam passes through the objective lens 50 again, and it is reflected by the fourth beam splitter 15d and diverges.

The diverging light beam having the wavelength λ3 passes through the third collimating lens 14c, and its course is modified when the light beam passes through the diffracting plate 17 before the light beam is incident on the third optical detector 18c. The subsequent procedure is the same as for the light beam having the wavelength λ1.

As shown in FIG. 3, the objective lens 50 is a single lens made of a plastic resin whose plane of incidence 51 and plane of emission 52 both are aspherical and whose plane of incidence 51 is convex.

The objective lens 50 can also be formed of a plurality of optical elements combined. In this arrangement, it is only required that a convex optical surface is provided on an object side of at least one-side optical elements of the combined optical elements and a diffracting structure 60 described later is provided at least on one of the object-side and image-side optical surfaces.

There is formed the diffracting structure 60 for giving the diffraction to an incoming beam in the entire area of the plane of incidence 51.

In this embodiment, the diffracting structure 60 is made up of a plurality of diffraction zones 61 having an action of diffracting the incoming beam, which are formed substantially concentrically around the light axis L.

The diffraction zones 61 are formed in saw teeth in a plan view (a meridian cross-sectional view) taken along the light axis L, so that it gives positive diffraction effects to the light beam by generating a given phase difference for a light beam having a specific wavelength incident on each diffraction bracelet 61.

The term “positive diffraction effects” means a diffracting action given for generating a spherical aberration in the lower direction relative to a passing light beam so as to set off a spherical aberration generated in the upper direction, for example, due to an elongated wavelength.

A start point 61a and an end point 61b (indicated at a single place in FIG. 3) of each diffraction bracelet 61 are located on a given aspherical surface S (hereinafter, referred to as “a generating aspherical surface”) shown in FIG. 3, and the shape of each diffraction bracelet 61 can be defined by a displacement in the direction of the light axis L relative to the generating aspherical surface S. The reference 62 (indicated at a single place in FIG. 3) designates a stepped surface.

The generating aspherical surface S can be defined by a function related to a distance from the light axis L with the light axis L as a center of rotation. A design method of the diffraction bracelet 61 has already been known, and therefore its description is omitted here. It is also possible to provide the phase difference generating structure only on the plane of emission 52 or to provide it on both of the plane of incidence 51 and the plane of emission 52.

By being provided with the diffracting structure 60, the objective lens 50 shown in this embodiment has a function of maintaining a wave aberration Δλ [λ rms] of a focused spot in a condition where a wavelength has changed from λ1 by 1 nm in a focused spot position where the wave aberration is a minimum within a range of |Δλ|≦0.040 at the time of incidence of a light beam having the wavelength λ1. Thereby, it is possible to perform the so-called color correction for decreasing an axial chromatic aberration and a spherical aberration to a diffraction limit or lower, for example, even if a wavelength of a light beam emitted from the light source 11 fluctuates due to a mode hop or the like.

Furthermore, it is possible to perform both securing the light volume and making corrections for aberration by selecting diffraction lights so that n≠m is satisfied where n (n is a natural number) is a diffraction order of a diffraction light having the maximum diffraction efficiency out of diffraction lights generated from the light beam having the wavelength λ1 due to a diffracting action produced by the diffracting structure and m (m is a natural number) is a diffraction order of a diffraction light having the maximum diffraction efficiency out of diffraction lights generated from the light beam having the wavelength λ2 due to a diffracting action produced by the diffracting structure.

The objective lens 50 is formed from a lens material satisfying 97≦T1≦99 where T1 [%/mm] is an optical transmittance of the light beam having the wavelength λ1, which does not include a reflection loss, to the thickness 1 mm of the objective lens 50.

The term “reflection loss” means a loss of a transmitted light caused by a reflection of a part of an incident light instead of a transmission of the light in a boundary between mediums different in optical density. Therefore, when a light is incident on a plate, the light has a reflection loss on the plane of incidence first, subsequently has a loss of the light volume during a passage through the lens material due to an absorption into the material, and has a reflection loss again on the plane of emission.

The term “optical transmittance which does not include a reflection loss” means an optical transmittance, in case that a loss of the light volume is caused only by a light absorption, in such a lens material as a distance where a light passes through is a unit length when the distance is converted into the air length.

The optical transmittance for the light beam having the wavelength λ1 is defined by the following equation (1):

$$Td = \frac{{( 1 - R )}^{2} Tid}{( 1 - {Tid}^{ 2} {R}^{2} )} , Inti = \frac{InTid}{d} \qquad ( 1 )$$

where d is a thickness (mm) in the above equation (1).

It is possible to measure a reflectance Td for the light beam having the wavelength λ1 with a lens reflectance measuring machine and to measure a transmittance R for the light beam having the wavelength λ1 with a spectro-photometer, by using a plate test piece of the same material as the lens material for the objective lens 50. The transmittance R means a ratio of an output light with respect to an incident light which includes all losses of light such as, for example, reflection loss, absorption loss, etc.

The measuring methods of the reflectance Td and the transmittance R are illustrative only and methods other than those can be used for the measurements.

Reference symbol Tid indicates an internal transmittance when d is a thickness of the test piece.

In the present invention, the term “internal transmittance” of the optical element means an optical transmittance for a light beam which has penetrated into the optical element having an optional thickness toward a measuring point therein in case that only a light absorption due to a lens material is the cause of a loss of the light volume.

In the present invention, means for attaining the above described optical transmittance and internal transmittance is not particularly limited, but it becomes possible to attain those by, for example, an appropriate selection of a lens material, mixing optional additives into the lens material, etc.

The following describes effects achieved by forming the objective lens 50 using a lens material satisfying 97≦T1≦99 where T1 [%/mm] is the optical transmittance T1 for the light beam having the wavelength λ1.

Referring to FIG. 4, there is shown a graph illustrating a relation between the transmittance R for the light beam having the wavelength λ1 and the numerical aperture NA of the objective lens 50 formed from the lens material satisfying 97≦T1≦99 where T1 [%/mm] is the optical transmittance, where L1 indicates a relation between the transmittance R and the numerical aperture NA and a relation between the internal transmittance Tid and the numerical aperture NA when considering only an effect of a stepped surface 62 of the diffraction bracelet 61. The reference L2 indicates a relation between the internal transmission Tid and the numerical aperture NA where d is the thickness of the objective lens 50.

Apparent from L1, the transmittance decreases in the high NA area due to a large effect of the stepped surface of the diffraction bracelet 61 in the high NA area, thus causing a decrease of the light volume.

As indicated by L2, however, the internal transmittance Tid is high in the high NA area correspondingly since the objective lens 50 whose plane of incidence 51 is convex has a tendency to have a lens thickness (a length in the direction of the light axis L) decreasing as being farther from the light axis L independently of the shape of the plane of emission 52.

The conventional objective lens formed from a lens material of the optical transmittance T1 of substantially 100% has a loss of the light volume equal to an addition of a loss caused by the stepped surfaces of the diffraction zones and a loss caused by the antireflection coating. The light beam having reached the inside of the objective lens without being affected by the stepped surfaces of the diffraction zones and the antireflection coating reaches the plane of emission substantially at a rate of 100%. Therefore, the rate of the light volume of the outgoing beam from the high NA area is less relative to the light volume of the outgoing beam from the low NA area, thus causing a variance in the light volume on the entire plane of emission.

On the other hand, the objective lens 50 of the present invention has an internal transmittance of the light beam having the wavelength λ1 increasing as the light beam having the wavelength λ1 passes through the objective optical element a shorter distance, thereby compensating the reduction of the light volume of the outgoing beam in the high NA area with the increase of the internal transmittance Tid. Thus, the rate of the light volume of the outgoing beam from the high NA area relative to the light volume of the outgoing beam from the low NA area does not decrease in comparison with the conventional objective lens 50, thereby suppressing the variance of the light volume on the entire plane of the emission 52.

Particularly, the optical transmittance T1 of the lens material is limited to a range of 97≦T1≦99, thereby securing the light volume necessary for reproducing and/or recording information from and/or on an AOD, in other words, maintaining the optical usability at high levels while suppressing the variance in the light volume on the entire plane of emission 52.

Particularly when using an AOD as a high-density optical disk, as shown in FIG. 3, it is possible to enhance the above effect of equalizing the light volume of the outgoing beam by using a lens having a configuration where ΔL1/L1 is within a range of 0.25≦ΔL1/L1≦0.5 where L1 [mm] is a distance that a light beam P4 having the wavelength λ1 passes through the objective lens 50 on the light axis L and ΔL1 [mm] is a distance that a light beam P5 having the wavelength λ1 passes through the objective lens 50 after being incident at hmax assuming that hmax/f1 is within a range of 0.63 to 0.67 where hmax is the maximum height from the light axis at which the light beam having the wavelength λ1 is incident on the plane of the incidence and f1 is a focal length of the objective lens 50 for the light beam having the wavelength λ1.

In addition, it is possible to further enhance the above effect by designing an objective lens 50 whose distance L1 is within a range of 1.4≦L1≦2.5 and whose focal distance f1 [mm] for the light beam having the wavelength λ1 is within a range of 2.0≦f1≦4.0.

Preferably the Abbe number νd1 for the light beam having the wavelength λ1 of the lens material is within a range of 50≦νd1≦60. In general, the refractive index of the lens material is not linear to the wavelength, but a change rate of the refractive index to a change of the wavelength increases in the short wavelength side, in other words, it is significantly dependent on the wavelength. Furthermore, the wavelength dependency greatly varies with the lens material. The wavelength dependency can be reduced to low by forming the objective lens 50 from the lens material of the Abbe number νd of 50 or higher with the consideration of this point. For example, even if a mode hop occurs when recording information on an optical disk, it is possible to reduce a change of the refractive index and to decrease the variance in the direction of the light axis L of the focused spot.

While the AOD is used as a high-density optical disk in this embodiment, the present invention is not limited to this, but it is possible to use a high-density optical disk satisfying 0.83≦hmax/f1≦0.87 and 0.09 mm≦t1 0.11 mm.

If this high-density optical disk is used, the above effect can be further enhanced by using an objective lens 50 satisfying the conditions: 0.35≦ΔL1/L1≦0.6; 1.4≦L1≦2.5 (L1 is the distance); and 1.0≦f1≦2.5 (f1 [mm] is the focal length).

### EMPIRICAL EXAMPLE 1

The following describes a first empirical example.

In this empirical example, similarly to one shown in FIG. 3, an objective lens has an aspherical plane of incidence and an aspherical plane of emission and has a plurality of diffraction zones, each having a sawtooth cross-section, formed around a light axis L as a diffracting structure. In addition, the objective lens has compatibility between two types of optical disks, namely an AOD and a DCD, using a light beam having a wavelength λ1 (407 nm) and a light beam having a wavelength λ2 (655 nm).

The objective lens is formed from a lens material of an optical transmittance T1 [%/mm] of 97.8 which does not include a reflection loss for the light beam having the wavelength λ1.

The following Table 1 and Table 2 show lens data of the objective lens.

TABLE 1
Focal length of objective lens: f1; 3.0 mm, f2; 3.08 mm
Image-side numerical aperture: NA1; 0.65, NA2; 0.65
Diffraction order: n1; 3, n2; 2
Magnification: m1; 0, m2; 0
L1: 1.88 [symbol]
L1: 0.825

| i-th plane | ri | di: 407 nm | ni: 407 nm | di: 655 nm | ni: 655 nm |
|---|---|---|---|---|---|
| 0 | | ∞ | | ∞ | |
| 1 | ∞ | 0.1* | | 0.1** | |
| 2 | 2.01556 | 1.88 | 1.559806 | 1.88 | 1.540725 |
| 3 | −11.95979 | 1.53 | 1.0 | 1.59 | 1.0 |
| 4 | ∞ | 0.60 | 1.61869 | 0.60 | 1.57752 |
| 5 | ∞ | | | | |

*: Aperture diameter Ô3.9 mm
**: Aperture diameter Ô4.0 mm
di: “di” designates a displacement from the i-th plan to the i + 1-th plan.

TABLE 2
Second plane
Aspherical coefficient

κ: −4.4219 × E−1
A4: 1.8037 × E−3
A6: 2.0831 × E−5
A8: 9.6492 × E−5
A10: +4.4043 × E−5
A12: −1.3358 × E−5

Optical path difference function (Blazed wave-
length: λB = 407 nm)

C2: −1.1179 × E−3
C4: −8.9435 × E−5
C6: −1.2270 × E−5
C8: +2.0945 × E−6
C10: −4.2570 × E−7

Third plane
Aspherical coefficient

κ: −7.7761 × E+1
A4: +6.1598 × E−3
A6: +1.9542 × E−3
A8: 2.0084 × E−3
A10: +5.3328 × E−4
A12: −6.3931 × E−5
A14: +2.8058 × E−6

As shown in Table 1, the objective lens in this embodiment has a focal length f₁ set to 3.00 mm, an image-side numerical aperture NA1 (equivalent to hmax/f₁) set to 0.65, and an imaging magnification m1 set to 0 when the first light source emits a light beam having a wavelength λ1 of 407 nm and has a focal length f₂ set to 3.08 mm, an image-side numerical aperture NA2 set to 0.65, and an imaging magnification m2 set to 0 when the second light source emits a light beam having a wavelength λ2 of 655 nm. In addition, there are settings of n1=3 where n1 is an order of a diffraction light having the maximum diffraction efficiency of the light beam having the wavelength λ1, n2=2 where n2 is an order of a diffraction light having the maximum diffraction efficiency of the light beam having the wavelength λ2, a distance L1=1.8, and a distance ΔL1=0.825 (ΔL1/L1=0.44).

The plane numbers 2 and 3 in Table 1 indicate a plane of incidence and a plane of emission of the objective lens, respectively. The references ri, di, and ni indicate a curvature radius, a position in the direction of the light axis L from the i-th plane to the (i+1)th plane, and a refractive index of each plane, respectively.

The second and third aspherical planes are formed to be axisymmetrical about the light axis L, defined by the following equation (2) for which the coefficients shown in Table 1 and Table 2 are substituted, respectively:

$$X ( h ) = \frac{( {h}^{2} / {r}_{i} )}{1 + \sqrt{1 - ( 1 + κ ) {( h / {r}_{i} )}^{2}}} + {\sum }_{i = 0}^{n} {A}_{2 i} {h}^{2 i} \qquad ( 2 )$$

where X(h) is an axis in the direction of the light axis L (it is assumed that the forward direction of the light is positive), κ is a conical coefficient, and A₂ᵢ is an aspherical coefficient.

The optical path length given to the light beam having each wavelength affected by the diffraction zones formed on the second plane is defined by the following equation (3) for which the coefficients shown in Table 2 are substituted as the optical path difference functions:

$$Φ ( h ) = ( n \times \frac{λ}{{λ}_{B}} ) + {\sum }_{i = 0}^{5} {B}_{2 i} {h}^{2 i} \qquad ( 3 )$$

In the equation (3), n: Diffraction order

λ: Wavelength

λ_{B}: Blazed wavelength

where B₂ᵢ is a coefficient of the optical path difference function. The blazed wavelength λB related to the diffraction zones on the second plane is 407 nm.

In the objective lens described in this embodiment, the variance of the wave aberration is suppressed to the diffraction limit of 0.07 λrms or lower, though it is not shown, therefore having a satisfactory color correcting function.

### EMPIRICAL EXAMPLE 2

The following describes a second empirical example.

Also in this empirical example, similarly to one shown in FIG. 3, an objective lens has an aspherical plane of incidence and an aspherical plane of emission and has a plurality of diffraction zones, each having a sawtooth cross-section, formed around a light axis L as a diffracting structure. In addition, the objective lens is arranged for using a light beam having a wavelength λ1 (405 nm) and for using a high-density optical disk with a protected substrate thickness t1 of 0.1 mm and an image-side numerical aperture NA1 of 0.85.

The objective lens is formed from a lens material of an optical transmittance T1 [%/mm] of 97.8 not including a reflection loss for the light beam having the wavelength λ1.

Table 3 and Table 4 show lens data of the objective lens.

TABLE 3
Focal length of objective lens: f1; 1.47 mm
Image-side numerical aperture: NA1; 0.85
Diffraction order: n1; 2
Magnification: m1; 0
L1: 1.85 [symbol]
L1: 0.959

| i-th plane | ri | di: 405 nm | ni: 405 nm |
|---|---|---|---|
| 0 | | ∞ | |
| 1 | ∞ | 0.0*** | |
| 2 | 1.03801 | 1.85000 | 1.560131 |
| 3 | −1.78978 | 0.39 | |
| 4 | ∞ | 0.1 | 1.6195 |
| 5 | ∞ | | |

***: Aperture diameter Ô2.5 mm
di: “di” designates a displacement from the i-th plan to the i + 1-th plan.

TABLE 4
Second plane
Aspherical coefficient

κ: −6.9580 × E−1
A4: +2.9452 × E−2
A6: +1.6406 × E−2
A8: −1.3854 × E−2
A10: +1.9945 × E−2
A12: −3.4172 × E−3
A14: −7.5862 × E−3
A16: +1.7237 × E−3
A18: +3.8045 × E−3
A20: −1.8959 × E−3

Optical path difference function (Blazed wave-
length: λB = 405 nm)

C2: −1.1000 × E−2
C4: −2.3084 × E−3
C6: −2.6232 × E−4
C8: −9.1590 × E−5
C10: −2.6649 × E−4

Third plane
Aspherical coefficient

κ: 7.7813 × E+1
A4: −3.3131 × E−1
A6: −8.8391 × E−1
A8: +1.3643 × E−0
A10: −1.5120 × E−0
A12: +1.0501 × E−0
A14: −3.3357 × E−1

As shown in Table 3, the objective lens in this embodiment has a focal length f₁ set to 1.47 mm, an image-side numerical aperture NA1 (equivalent to hmax/f₁) set to 0.85, and an imaging magnification m1 set to 0 when the first light source emits a light beam having a wavelength λ1 of 405 nm. In addition, there are settings of n1=2 where n1 is an order of a diffraction light having the maximum diffraction efficiency of the light beam having the wavelength λ1, a distance L1=1.85 mm, and a distance AL1=0.959 mm (ΔL1/L1=0.52).

The plane numbers 2 and 3 in Table 3 indicate a plane of incidence and a plane of emission of the objective lens, respectively. The references ri, di, and ni indicate a curvature radius, a position in the direction of the light axis L from the i-th plane to the (i+1)th plane, and a refractive index of each plane, respectively.

The second and third aspherical planes are formed to be axisymmetrical about the light axis L, defined by the above equation (2) for which the coefficients shown in Table 3 and Table 4 are substituted, respectively.

The optical path length given to the light beam having each wavelength caused by the diffraction zones formed on the second plane is defined by the above equation (3) for which the coefficients shown in Table 4 are substituted as the optical path difference functions. The blazed wavelength λB related to the diffraction zones on the second plane is 405 nm.

In the objective lens described in this embodiment, the variance of the wave aberration is suppressed to the diffraction limit of 0.07 λrms or lower, though it is not shown, therefore having a satisfactory color correcting function.

What is claimed is:

1. An objective optical element for use in an optical pickup device at least reproducing and/or recording information from and/or on a first optical information recording medium by focusing a first light beam having a wavelength λ1 (380 nm≦λ1≦450 nm) on an information recording surface of said first optical information recording medium having a protected substrate thickness t1 (0 mm<t1≦0.7 mm),
wherein the objective optical element has a single lens having a convex optical surface on the object side, a diffracting structure having positive diffraction effects formed at least on one of optical surfaces thereof, and an internal transmittance of the first light varying in response to a distance that the first light beam passes through the single lens.

2. The objective optical element according to claim 1, wherein the internal transmittance of the first light beam becomes greater as a distance that the first light beam passes through the single lens is shorter.

3. The objective optical element according to claim 1, wherein the objective optical element satisfies 97≦T1≦99 where T1 [%/mm] is an optical transmittance for a thickness of 1 mm in the single lens not including a reflection loss for the first light beam.

4. The objective optical element according to claim 1, wherein the objective optical element satisfies |Δλ|≦0.040 where Δλ [λ rms] is a wave aberration of a focused spot in a condition where the wavelength has changed by 1 nm from λ1 in a focused spot position where the wave aberration is a minimum at the time of incidence of the first light beam.

5. The objective optical element according to claim 1, wherein the objective optical element satisfies 50≦νd1≦60 where νd1 is an Abbe number of the lens material for the first light beam.

6. The objective optical element according to claim 1, wherein the objective optical element satisfies 0.63≦hmax/f1≦0.67 and 0.5 mm≦t1≦0.7 mm where hmax is a maximum height from a light axis of the light beam having the wavelength λ1 incident on the object-side optical surface of the single lens and f1 is a focal length of the objective optical element for the first light beam.

7. The objective optical element according to claim 6, wherein the objective optical element satisfies 0.25≦ΔL1/L1≦0.5 where L1 [mm] is a distance that the first light beam passes on the light axis within the objective optical element and ΔL1 [mm] is a distance that the light beam having the wavelength λ1 incident on the object-side optical surface at the height hmax passes through an area within the objective optical element.

8. The objective optical element according to claim 7, wherein the distance L1 is within the range of 1.4≦L1≦2.5.

9. The objective optical element according to claim 6, wherein the focal length f1 [mm] for the first light beam is within the range of 0≦f1≦4.0.

10. The objective optical element claim 1, wherein the objective optical element satisfies 0.83≦hmax/f1≦0.87 and 0.09 mm≦t1≦0.11 mm where hmax is a maximum height from a light axis of the first light beam incident on the object-side optical surface of the single lens and f1 is a focal length of the objective optical element for the light beam having the wavelength λ1.

11. The objective optical element according to claim 10, wherein the objective optical element satisfies 0.35≦ΔL1/L1≦0.6 where L1 [mm] is a distance that the first light beam passes on the light axis within the objective optical element and ΔL1 [mm] is a distance that the light beam incident on the object-side optical surface of the single lens at the height hmax passes through an area within the objective optical element.

12. The objective optical element according to claim 11, wherein the distance L1 is within the range of 1.4≦L1≦2.5.

13. The objective optical element according to claim 10, wherein the focal length f1 [mm] for the first light beam is within the range of 1.0≦f1≦2.5.

14. The objective optical element according to claim 1, wherein the objective optical element is for use in an optical pickup device further capable of reproducing and/or recording information from and/or on a second optical information recording medium by focusing a second light beam having a wavelength λ2 (640 nm≦λ2 680 nm) on an information recording surface of the second optical information recording medium having a protected substrate thickness t2 (0.5 mm≦t2≦0.7 mm).

15. The objective optical element according to claim 14, wherein the objective optical element satisfies n≠m where n (n is a natural number) is a diffraction order of a diffraction light having a maximum diffraction efficiency out of diffraction lights generated from the first light beam due to a diffracting action produced by the diffracting structure and m (m is a natural number) is a diffraction order of a diffraction light having a maximum diffraction efficiency out of diffraction lights generated from the light beam having the wavelength λ2 due to a diffracting action produced by the diffracting structure.

16. The objective optical element according to claim 1, wherein the objective optical element is for use in an optical pickup device further capable of reproducing and/or recording information from and/or on a third optical information recording medium by focusing a third light beam having a wavelength λ3 (750 nm≦λ3≦850 nm) on an information recording surface of the third optical information recording medium having a protected substrate thickness t3 (1.1 mm≦t3≦1.3 mm).

17. An objective optical element for use in an optical pickup device at least reproducing and/or recording information from and/or on a first optical information recording medium by focusing a first light beam having a wavelength λ1 (380 nm≦λ1≦450 nm) on an information recording surface of the first optical information recording medium having a protected substrate thickness t1 (0 mm<t1≦0.7 mm),
wherein the objective optical element is formed by a plurality of optical elements;
wherein there is provided a convex optical surface on an object side of at least one of the plurality of optical elements and a diffracting structure having positive diffraction effects is formed at least on one of optical surfaces thereof; and
wherein an internal transmittance of the first light in at least one of the plurality of the optical elements varies in response to a distance that the first light beam passes through the optical element.

18. The objective optical element according to claim 17, wherein the internal transmittance of the first light beam in the optical element, in which the internal transmittance of the first light beam varies in response to a distance that the first light beam passes through the optical element, becomes greater as a distance that the first light beam passes through the objective optical element is shorter.

19. The objective optical element according to claim 18, wherein the objective optical element satisfies 97≦T1≦99 where T1 [%/mm] is an optical transmittance for a thickness of 1 mm in the optical element, in which the internal transmittance of the first light beam varies in response to a distance that the first light beam passes through the optical element, not including a reflection loss for the first light beam.

20. The objective optical element according to claim 17, wherein the objective optical element satisfies |Δλ|≦0.040 where Δλ [λ rms] is a wave aberration of a focused spot in a condition where the wavelength has changed by 1 nm from λ1 in a focused spot position where the wave aberration is a minimum at the time of incidence of the first light beam.

21. The objective optical element according to claim 17, wherein the objective optical element satisfies 50≦νd1≦60 where νd1 is an Abbe number of the lens material, which consists of the optical element in which the internal transmittance of the first light beam varies in response to a distance that the first light beam passes through the optical element, for the first light beam.

22. The objective optical element according to claim 1, wherein the lens material consisting of the single lens is resin.

23. The objective optical element according to claim 17, wherein the lens material consisting of the optical element, in which the internal transmittance of the first light beam varies in response to a distance that the first light beam passes through the optical element, is resin.

24. An optical pickup device, comprising the objective optical element according to claim 1.

25. An optical pickup device, comprising the objective optical element according to claim 17.
